(19) United States
(12) Patent Application Publication
(10) Pub. No.: US 2005/0086699 A1
(43) Pub. Date: Apr. 21, 2005

(54) Video relay system and method

(75) Inventors: Wayne G. Hahn, Aurora, NE (US); Greg E. Stephens, Shelton, NE (US)

Correspondence Address: FOLEY & LARDNER, 150 EAST GILMAN STREET, P.O. BOX 1497, MADISON, WI, 53701-1497, US

(73) Assignee: Hamilton Relay, Inc.

(21) Appl. No.: 10/687,185

(22) Filed: Oct. 16, 2003

(51) Int. Cl. H04N 7/173; H04N 7/16

(52) U.S. Cl. 725/106; 725/135; 725/110; 725/109

(57) ABSTRACT

A system for relaying communications between a first device and a second device utilizing a third device as an intermediary where the second device is a telephone on a plain old telephone system network and the communications between the first device and third device involve video. The system includes a first input and output communication device coupled to a network and configured to send and receive communication messages; a server device that sets up the text, video, and audio, routing them to the appropriate devices; a second input and output communication device coupled to a plain old telephone system; and a third input and output communication device coupled to the network via the server device and receiving the separated text, video, and audio to enable a communication session between the first and third input and output communication devices. The third input and output communication device relays communication messages from the first input and output communication device to the second input and output communication device by voice over the plain old telephone system.

### FIELD OF THE INVENTION

The present invention relates to communication methods and systems for the deaf, hearing and/or speech impaired. More specifically, the present invention relates to a video relay system and method.

### BACKGROUND OF THE INVENTION

Various technologies have been developed to enable hearing-impaired individuals to communicate using telephone communication systems. For example, text telephones, such as Telecommunication Devices for the Deaf (TDD), enable deaf, hard of hearing, speech-impaired individuals to communicate over the telephone with hearing and speaking parties using conventional telephones. In TDD systems, the hearing-impaired person typically uses a telephone teletype keyboard or TTY, a specially equipped device with a keyboard, to type messages and a text display for presenting responses to the caller.

TDD devices typically require a Weitbrecht/Baudot-compatible modem. In general, a computer cannot communicate directly to TDD because each uses a different coding system to transmit messages over telephone lines. Modems and software are available that can be installed on a computer that allow the computer to communicate directly with a Baudot modem and a TDD. However, such configurations do not solve the need of a hearing-impaired person being able to call anyone at anytime.

Telecommunication relay services or dual party relay services enable deaf, hard of hearing, speech-impaired individuals to employ text telephones for engaging in a communication session over a telephone network with a person who has a conventional voice telephone. Relay services involve a hearing-impaired individual using a keyboard to communicate and a display device to understand what is being said by the other party. The hearing person hears what is being said and uses his voice to communicate. A relay operator acts as the interface in this situation. The relay operator relays information from one communication protocol to another. For example, the relay operator types what the hearing person says and sends the text to the hearing-impaired person. The relay operator reads aloud text messages from the hearing-impaired person so that the hearing person can hear the message.

Conventional relay services are limited. For example, the communication from the relay operator to the hearing-impaired individual is limited to the speed at which the relay operator can type what he or she hears from the non-hearing-impaired individual at the other end of the telephone call.

Thus, there is a need for an improved relay system. Further, there is a need to better facilitate the speed and clarity of telephone relay conversations by allowing the relay operator to use sign language that is communicated by video signal to the hearing-impaired individual. Even further, there is a need to utilize internet technologies to enable video relay services.

### SUMMARY OF THE INVENTION

An exemplary embodiment includes a system for relaying communications between a first device and a second device utilizing a third device as an intermediary where the second device is a telephone on a plain old telephone system network and the communications between the first device and third device involve video. The system includes a first input and output communication device coupled to a network and configured to send and receive communication messages; a server device that separates text, video, and audio from the communication messages sent by the first input and output communication device; a second input and output communication device coupled to a plain old telephone system; and a third input and output communication device coupled to the network via the server device and receiving the separated text, video, and audio to enable a communication session between the first and third input and output communication devices. The third input and output communication device relays communication messages from the first input and output communication device to the second input and output communication device by voice over the plain old telephone system.

Another exemplary embodiment relates to a method of relaying communications between a first device and a second device utilizing a relay device as an intermediary where the second device is a telephone on a plain old telephone system network and the first device and the relay device utilize video in communication. The method includes communicating video, audio, and text communication messages with a first input and output communication device coupled to a network; separating video, audio, and text communication messages from the first input and output communication device; receiving the separated text, video, and audio communication messages at a relay communication device and establishing a communication session between the first input and output communication device and the relay device; and communicating with a second input and output communication device over a plain old telephone system network communications based on the communications received from the first input and output communication device.

Still another exemplary embodiment relates to a system for relaying communications between a first device and a second device utilizing a relay device as an intermediary where the second device is a telephone on a plain old telephone system network and the first device and the relay device utilize video in communication. The system includes means for communicating video, audio, and text communication messages with a first input and output communication device coupled to a network; means for separating video, audio, and text communication messages from the first input and output communication device; means for receiving the separated text, video, and audio communication messages at a relay communication device and means for establishing a communication session between the first input and output communication device and the relay device; and means for communicating with a second input and output communication device over a plain old telephone system network communications based on the communications received from the first input and output communication device.

### BRIEF DESCRIPTION OF THE DRAWINGS

The exemplary embodiments will be described with reference to the accompanying drawings, wherein like numerals denote like elements; and

FIG. 1 is a diagram of a video relay system in accordance with an exemplary embodiment;

FIG. 2 is a flow diagram of an exemplary process of operation for the voice relay system of FIG. 1;

FIG. 3 is a flow diagram of exemplary operations in a video relay call with HCO (hearing carry over);

FIG. 4 is a flow diagram of exemplary operations in a video relay call with VCO (voice carry over).

FIG. 5 is a flow diagram of exemplary operations in a video relay call with ASL (American Sign Language).

FIG. 6 is an exemplary screen display for the video relay service of FIG. 1; and

FIG. 7 is an exemplary screen display depicting communication screens in the video relay service of FIG. 1.

### DETAILED DESCRIPTION OF EXEMPLARY EMBODIMENTS

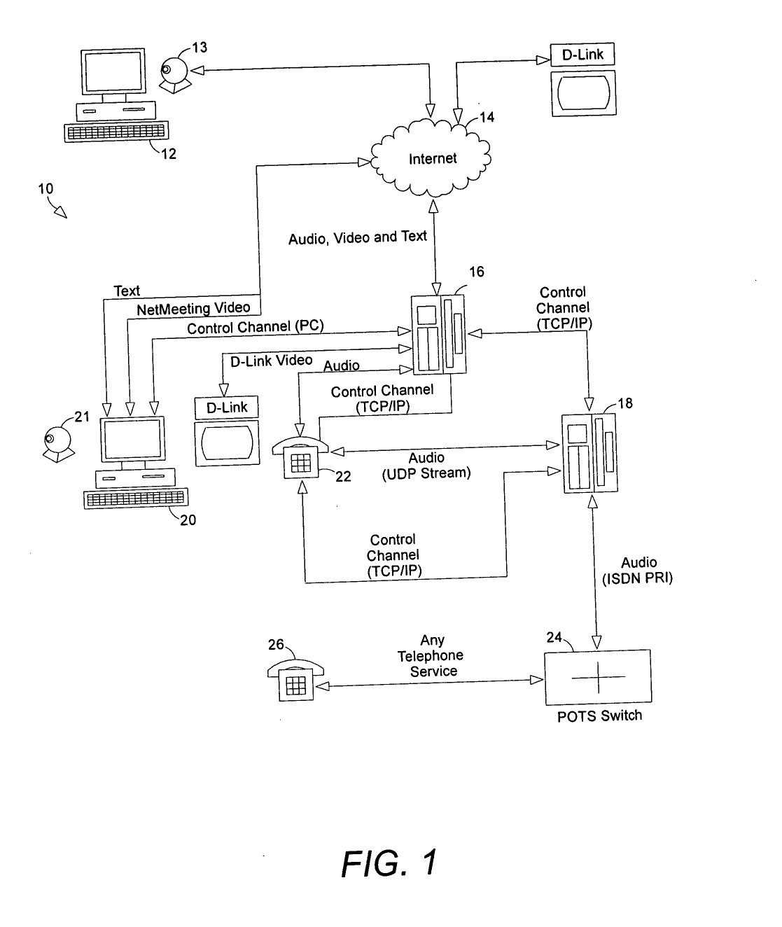

FIG. 1 illustrates an exemplary video relay system 10 including a personal computer (PC) 12, a digital camera 13, a network 14, a server 16, a router 18, a workstation computer 20, a digital camera 21, a SIP (Session Initiation Protocol) telephone 22, a switch 24, and a telephone 26. The PC 12 is coupled to the network 14 via a connection, such as a broadband communication connection. The network 14 is preferably the Internet. The server 16 is coupled to the network 14 and receives audio, video, and text from the network 14.

The PC 12 can be replaced by any of a variety of devices, including, for example, a handheld wireless communication device, a library workstation computer, or a video phone. The digital camera 13 can be integrated into the PC 12 or other comparable device. In an exemplary embodiment, the workstation computer 20, the digital camera 21, and the SIP telephone 22 make up one video relay interpreter workstation.

The PC 12, video camera 13, network 14, and server 16 enable the voice portion to be communicated over IP (VOIP) along with the video and text, allowing for what is called VCO (Voice Carryover) or HCO (Hearing Carryover) without the use of an additional communication device and telephone line. VCO allows deaf and hard-of-hearing users to speak directly to a hearing person. The hearing person speaks to a video relay interpreter who relays the message in ASL (and text if requested) so that the deaf or hard-of-hearing person can understand. HCO allows speech-disabled users with hearing to listen to the person they are calling and type conversation for the video relay interpreter to read to the standard telephone user.

The server 16 is coupled to the router 18 by a control channel. The server 16 sets up the connection for the audio, video, and text with the workstation computer 20 and telephone 22. The workstation computer 20 and telephone 22 are located at an interpreter relay location. A control channel from the server 18 is coupled to the telephone 22. The router 18 communicates audio from the telephone 22 to the switch 24, which is a plain old telephone service (POTS) switch. The audio is directed through the switch 24 to the telephone 26.

After a customer connects using the PC 12 at the network 14, the call or communication is split into its text, video and audio components using H.323 protocol definitions. The H.323 protocol defines the transmission of video and audio via IP packets. The audio component is directed to a SIP (Session Initiation Protocol) phone 22. The video and text portion is directed to the workstation 20 of a video relay interpreter. The video interpreter completes the call through PSTN (Public Switched Telephone Network) telephones. The video interpreter interprets sign language from the impaired person for the hearing person to understand and signs the messages from the non-impaired person to the hearing impaired person. The video portion of the communication can be a NetMeeting video, a D-Link video, or any H.323 capable device that can be reached through the Internet.

The H.323 protocol is designed for video conferencing over the Internet. It provides for the transmission of audio, video, and data communications through packet-based networks. It is made up of several objects, specifying the components, protocols, and procedures needed for multimedia communication over packet-based networks. Packet-based networks include TCP/IP-based (e.g., the Internet) as well as other network methodologies that transmit data via packets. The H.323 protocol can be applied to a variety of situations, such as audio only (IP telephony); audio and video; audio and data; and audio, video and data.

The incoming H.323 data stream originates at the hearing- or speaking-impaired person's PC or other H.323 capable device which is connected to the Internet with a broadband connection capable of supporting video streams. As it arrives at the server 16, the packet stream is examined and determined whether it is a NetMeeting video stream or something else.

If the video stream is a NetMeeting video stream, an available video relay interpreter is identified and the H.323 data stream split into its video, audio and data components. The video and data components are routed to the workstation 20 at the video relay interpreter and the audio component is routed to the SIP (Session Initiation Protocol) phone 22. A control channel communicates from the router 18 via TCP/IP to signal the SIP phone 22.

The incoming NetMeeting video and data uses a RTP (Real-Time Protocol) stream. RTP is a derivative of UDP (User Datagram Protocol) in which a time-stamp and sequence number is added to the packet header. This extra information allows the receiving device to re-order out of sequence packets, discard duplicates, and synchronize audio and video after an initial buffering period. Real-Time Control Protocol (RTCP) is used to control RTP. The audio RTP goes to the SIP phone 22 and the video and text are directed to the workstation 20.

The SIP phone 22 is then used to conference the outgoing call. The number to be called on the SIP phone 22 comes from the workstation 20. The server 16 opens a control channel between the SIP phone 22 and the router 18. The connection is then a SIP to SIP connection. The router 18 places the call through an ISDN connection to a standard telephone switch.

The conversation connection is then complete and the workstation 20 is used to control the Voice Carry Over (VCO) and the Hearing Carry Over (HCO). If one or the other is requested, then the audio is carried through in both directions. ASL interpretation is performed between the call originator and the workstation 20 through digital cameras and video display on the workstation monitor.

If the video portion of the data stream is created with something other than NetMeeting, such as Polycom or D-Link, the video stream is routed to the workstation 20 through a D-Link camera/device at this time. In the case of D-Link, a D-Link connection can be made with a computer monitor or with a properly configured television. D-Link communications sessions involve the use of Internet Protocol (IP) addresses but not an Internet browser. The D-Link audio and video interface is processed through server 16.

If the customer at the PC 12 desires VCO (Voice Carryover), the audio component is conferenced in the SIP phone and can be heard by either or both parties of the conversation along with the operator for interpretation purposes. This is possible over the network 14 by splitting the components and routing the audio to a SIP phone which has the capability to conference the calls. The video relay interpreter then can sign the hearing person's message and the speaking or hearing impaired person can see the video relay interpreter interpreting in sign language and hear the called person's speech at the same time, expediting the speed of the conversation if they have some hearing. Many hearing-impaired people have some degree of capability for hearing or speaking. If the caller is speech capable, the hearing-impaired person can speak directly to the hearing person without having to sign to the interpreter and have them translate. If the caller has hearing but cannot speak, he or she can hear the called person's comments directly and the interpreter can help translate when clarification is requested. The non-hearing person is signed to by the video interpreter.

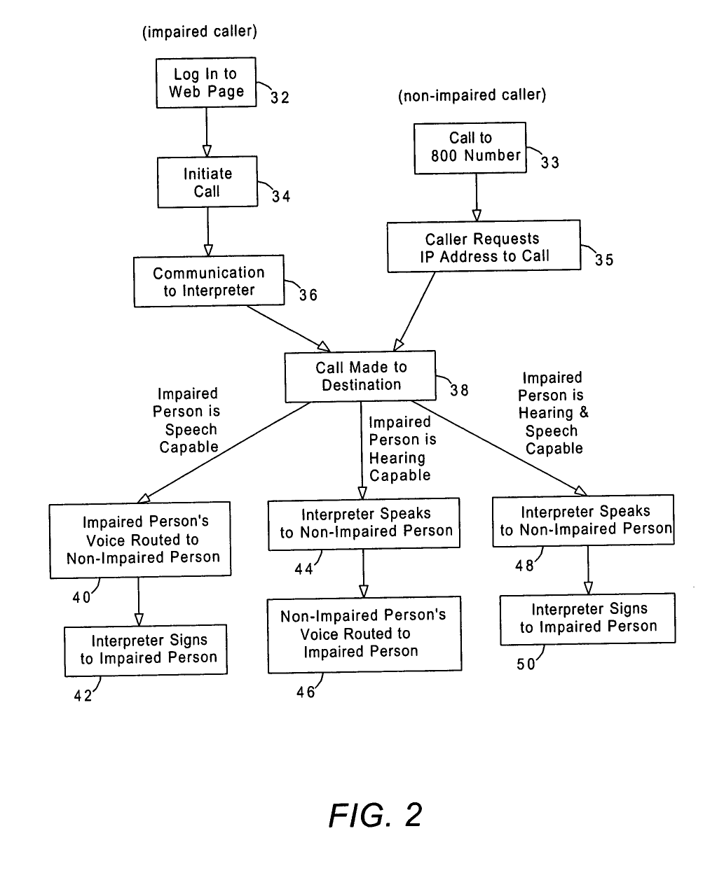

FIG. 2 illustrates a flow diagram of an exemplary process of operation for the voice relay system 10. Additional, fewer, or different operations may be performed. In an operation 32, an impaired caller logs onto a video relay web site using a broadband connection. At the video relay web site, the impaired caller initiates a call in an operation 34, choosing whether to use previously entered profile information or not. The connection uses H.323 protocols and travels over the Internet to a server where the video, text, and audio are routed to the appropriate device at a video interpreter's workstation.

In an exemplary embodiment, the interpreter's workstation (VRS workstation) consists of a standard personal computer (PC) and a SIP (Session Initiated Protocol) phone. An Internet Engineering Task Force (IETF) standard, SIP is an open, Internet-genuine protocol for establishing and managing multi-party, mixed-media sessions over converged networks. The audio portion of the conversation is conferenced with the called person's telephone using the voice over IP capability of the SIP phone and controlled by the server. In the situation where the caller is non-impaired, a call is made to a phone number (e.g., a toll free 800 number) using the plain old telephone system (POTS) in an operation 33. Once the call is received, the non-impaired caller requests a specific internet protocol (IP) address of an impaired person to be called in an operation 35. In an operation 38, the server initiates a destination call to a non-impaired person using standard PSTN switches (POTS switch) and to an impaired person over the Internet. The non-impaired called person's service can be any telephone, line or cellular. Once the complete connection is made, there are at least three people in a two-way conversation.

For the hearing impaired but speech capable person with a microphone on their PC, he or she can speak a message. In an operation 40, the speech of the impaired person is carried from the Internet through to the PSTN where the non-impaired person can hear them, respond to the message and the interpreter will sign their response back to the impaired person in an operation 42.

For the speech impaired, but hearing capable person with speakers on their PC, he or she can sign a message. The interpreter speaks the message to the non-impaired person in operation 44 who then responds. The spoken response is then translated to IP packets sent out over the Internet where the impaired person can hear it without waiting for the interpreter in operation 46.

For the hearing and speech impaired, the impaired person signs a message and in an operation 48 the interpreter speaks it for them to the non-impaired person. The non-impaired person responds and the message is signed back to the impaired person over the Internet in an operation 50.

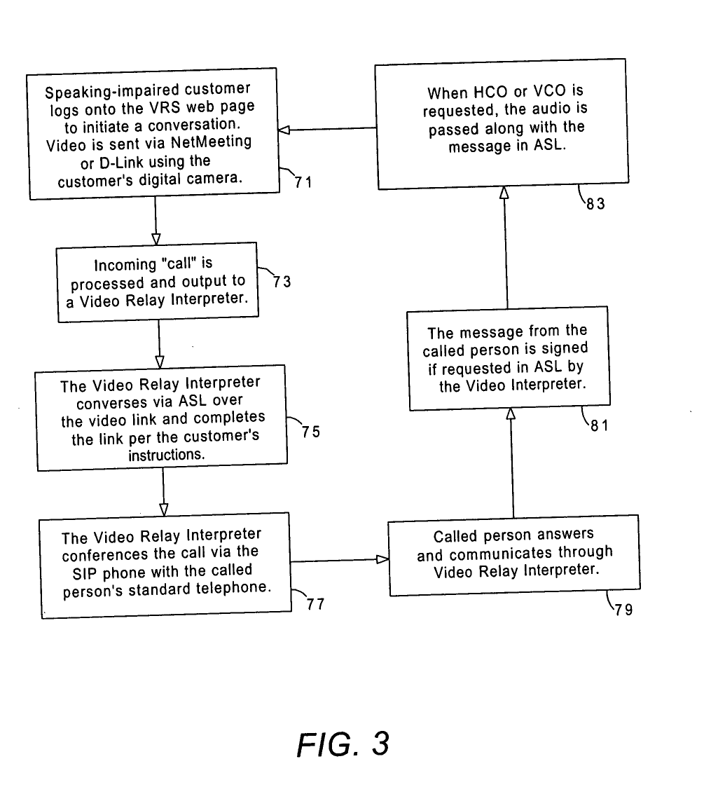

FIG. 3 illustrates exemplary operations in a video relay call with HCO (hearing carry over). In an operation 71, a speaking-impaired customer using NetMeeting logs onto a video relay service (VRS) web page to initiate a conversation. A D-Link user is provided an IP address from a web page or a brochure or some other source. The D-Link user programs the IP address into the D-Link device to initiate a communication session. Video is sent via a NetMeeting or D-Link application using the impaired person's digital camera. In an operation 73, the incoming communication from the customer is processed by a server and output to a video relay interpreter. In an operation 75, the video relay interpreter converses using American Sign Language (ASL) or some other sign language over the video link. The video relay interpreter completes the communication link according to the impaired person's instructions.

In an operation 77, the video relay interpreter conferences the call via a standard telephone system, speaking messages to the caller. In an operation 79, the called person answers and communicates through the video relay interpreter. In an operation 81, the message from the called person is signed, if necessary, in ASL by the video relay interpreter. In some situations, signing is only one direction. For example, someone who cannot hear but can speak only needs to be signed to and does not need to sign back. In operation 83, when HCO or VCO is requested, the audio is passed along with the message in ASL. As such, the oral message can be heard by the speaking impaired but hearing capable. Further, the oral message can be heard by the non-impaired when communicating with someone who is hearing impaired, but speaking capable.

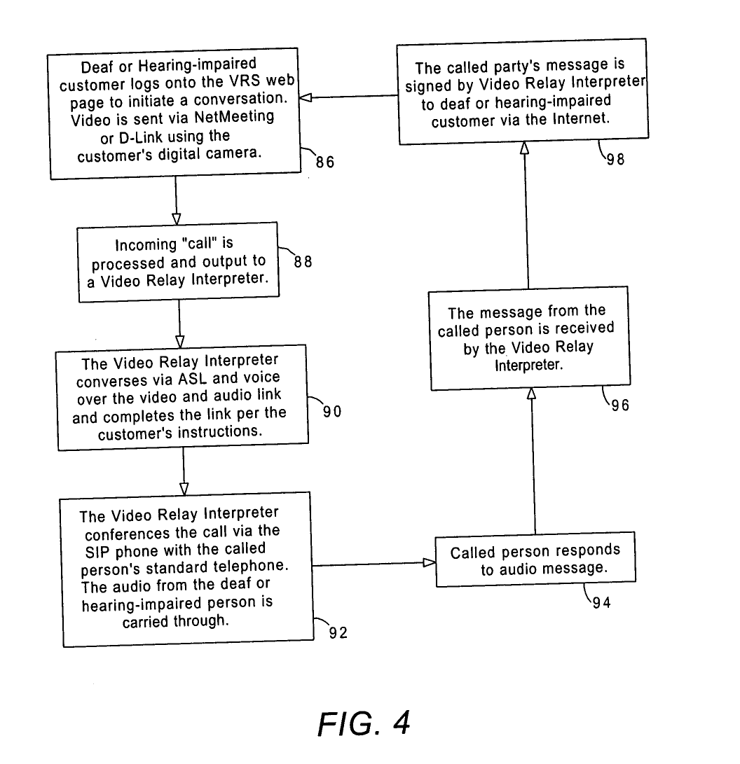

FIG. 4 illustrates exemplary operations in a video relay call with VCO (voice carry over). In an operation 86, a hearing-impaired customer logs onto the video relay service (VRS) web page to initiate a conversation. Video is transmitted through the Internet and processed by NetMeeting, D-Link, or any H.323 capable device using the customer's digital camera. In an operation 88, the incoming communication is processed and output to a video relay interpreter. In an operation 90, the video relay interpreter converses via ASL (or other sign language) and completes the communication link according to the customer's instructions. Voice is communicated to the hearing-impaired customer using the video and audio link.

In an operation 92, the video relay interpreter conferences the call via a standard telephone system, speaking the message to the called person. The audio from the hearing-impaired person is carried through. In an operation 94, the called person responds to an audio message. In an operation 96, the audio message from the called person is received by the video relay interpreter, and, in an operation 98, the called party's message is signed by the video relay interpreter to the hearing-impaired customer via the Internet.

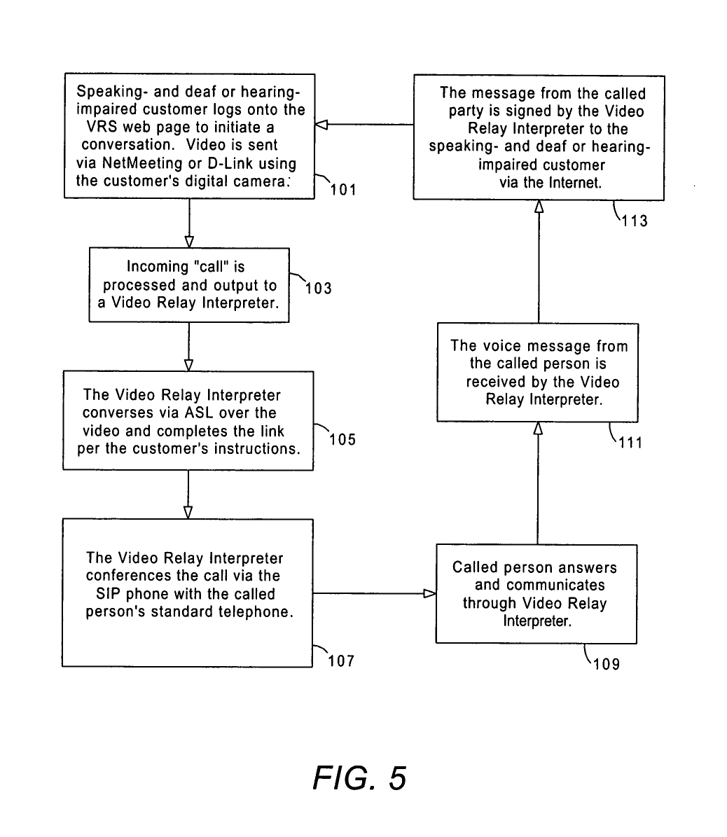

FIG. 5 illustrates exemplary operations in a video relay call with ASL (American Sign Language). In an operation 101, a speaking- and hearing-impaired customer logs onto a video relay service (VRS) web page to initiate a conversation. Video is sent via a NetMeeting, D-Link, or any H.323 application using the customer's digital camera. In an operation 103, the incoming communication from the customer is processed by a server and output to a video relay interpreter. In an operation 105, the video call interpreter converses using American Sign Language (ASL) or some other sign language over the video link. The video relay interpreter completes the communication link according to the customer's instructions.

In an operation 107, the video relay interpreter conferences the call via the SIP phone with a standard telephone system, speaking messages to the caller. In an operation 109, the called person answers and communicates through the video relay interpreter. In an operation 111, the voice message from the called person is received by the video relay interpreter. In an operation 113, the message from the called person is signed in ASL (or another sign language) by the video relay interpreter.

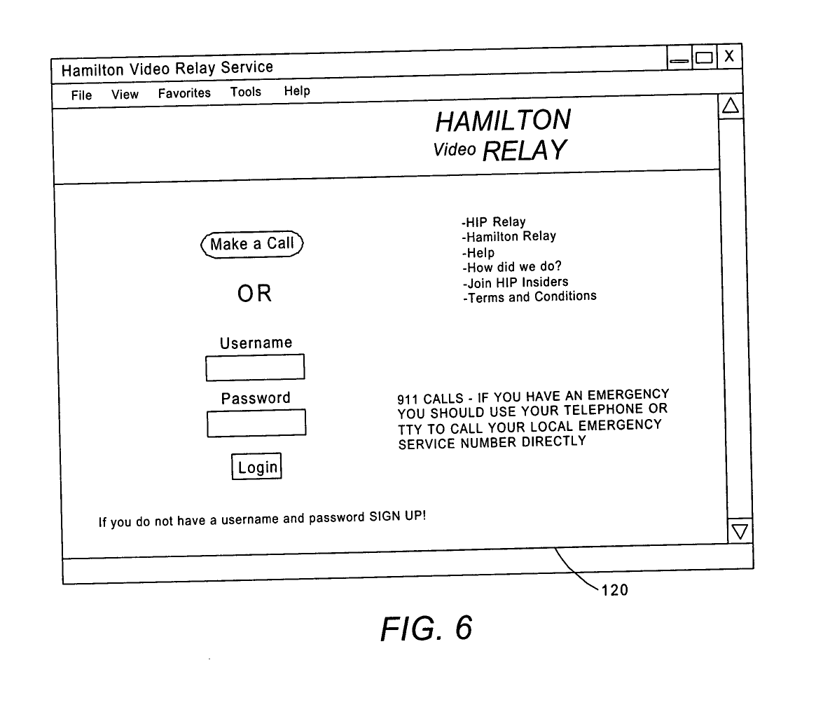

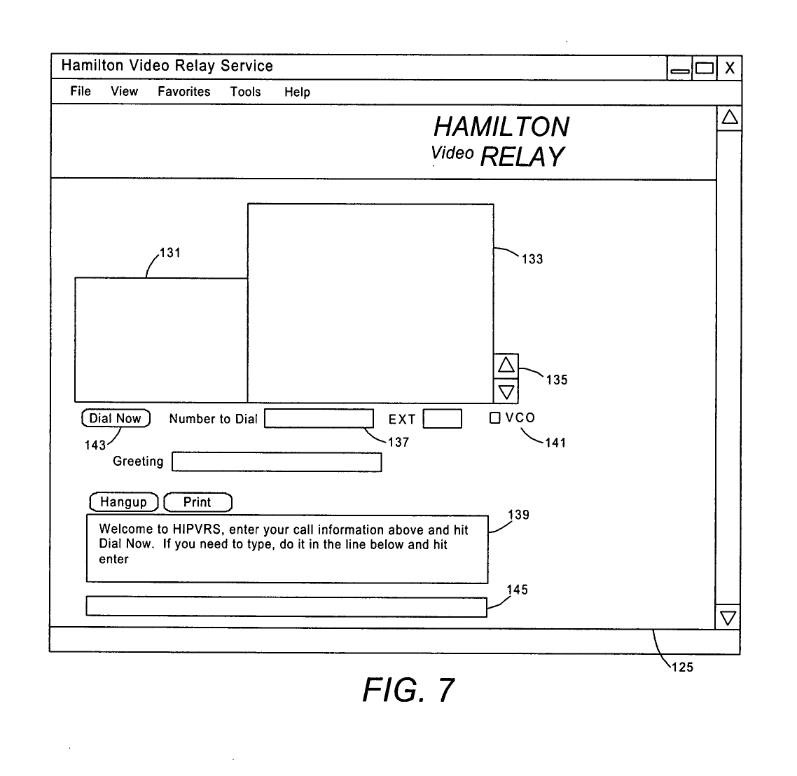

FIG. 6 illustrates an exemplary screen display 120 for a video relay service provided over the Internet. The screen display 120 provides information regarding the service and a login feature requiring a username and password. FIG. 7 illustrates an exemplary screen display 125 depicting communication screens in the video relay service. The screen display 125 includes a video portion 131, a video portion 133, a video size selector 135, a number input text box 137, a text portion 139, a VCO select box 141, a dial button 143, and a response box 145. Other functional portions, boxes, and buttons may be used.

The video portion 131 can be an outgoing video display box that displays the customer using the service for the customer to see what is being transmitted in the communication. The video portion 133 can be an incoming video display box that displays the video relay interpreter to the customer. The video size selector 135 allows the customer to control the size of the video portion 133. The number input text box 137 can be a location for the customer to input a plain old telephone service (POTS) telephone number that he or she desires to call. The text portion 139 can display text sent from the video relay instructor and other information for the customer. The VCO select box 141 can be a check box that allows the customer to select voice carry over as an operating mode. The dial button 143 provides an input for the customer to select the start of the communication session. The response box 145 is a location where the customer can respond by typing a message, if needed.

The screen display 125 can include fewer or more input or display mechanisms. For example, different displays can be used for handheld, wireless devices such as a personal digital assistant (PDA) or a wireless application protocol (WAP) phone. The screen display 125 can also be modified based on bandwidth availability. For example, size of video portions can be larger where communication speeds allow for it.

In the description, for purposes of explanation, numerous specific details are set forth to provide a thorough understanding of exemplary embodiments of the invention. It will be evident, however, to one skilled in the art that the invention may be practiced without these specific details. In other instances, well-known structures and devices are shown in block diagram form to facilitate description of the exemplary embodiments.

It is understood that although the detailed drawings and specific examples describe exemplary embodiments of a video relay system and method, they are for purposes of illustration only. The exemplary embodiments are not limited to the precise details and descriptions described herein. For example, although particular devices and structures are described, other devices and structures could be utilized according to the principles of the present invention. Various modifications may be made and the details disclosed without departing from the spirit of the invention as defined in the following claims.

1. A system for relaying communications between a first device and a second device utilizing a third device as an intermediary where the second device is a telephone on a plain old telephone system network and the communications between the first device and third device involve video, the system comprising:
a first input and output communication device coupled to a network and being configured to send and receive communication messages;
a server device that separates text, video, and audio from the communication messages sent by the first input and output communication device;
a second input and output communication device coupled to a plain old telephone system; and
a third input and output communication device coupled to the network via the server device and receiving the separated text, video, and audio to enable a communication session between the first and third input and output communication devices, the third input and output communication device relaying communication messages from the first input and output communication device to the second input and output communication device by voice over the plain old telephone system.

2. The system of claim 1, wherein the audio communication between the first input and output communication device and the third input and output communication device is communicated using internet protocol (IP).

3. The system of claim 1, wherein the video communication between the first input and output communication device and the third input and output communication device comprises sign language.

4. The system of claim 1, wherein the first input and output communication device comprises a computer and a digital camera.

5. The system of claim 1, wherein the first input and output communication device comprises a screen display having a video portion and a text portion.

6. The system of claim 1, wherein the first input and output communication device comprises a wireless communication device.

7. The system of claim 1, further comprising a router that directs communication between the second and third input and output communication devices.

8. The system of claim 1, wherein the video separated by the server device comprises NetMeeting video.

9. The system of claim 1, wherein the video separated by the server device comprises D-Link video.

10. A method of relaying communications between a first device and a second device utilizing a relay device as an intermediary where the second device is a telephone on a plain old telephone system network and the first device and the relay device utilize video in communication, the method comprising:
communicating with a first input and output communication device coupled to a network, the first input and output device being configured to send and receive video, audio, and text communication messages;
separating video, audio, and text communication messages from the first input and output communication device;
receiving the separated text, video, and audio communication messages at a relay communication device and establishing a communication session between the first input and output communication device and the relay device; and
communicating with a second input and output communication device over a plain old telephone system network communications based on the communications received from the first input and output communication device.

11. The method of claim 10, wherein the audio communication between the first input and output communication device and the relay communication device is communicated using internet protocol (IP).

12. The method of claim 10, wherein the video communication between the first input and output communication device and the relay input and output communication device comprises sign language.

13. The method of claim 10, wherein the communication messages are communicated using the H.323 protocol.

14. The method of claim 10, further comprising calculating billing data based on minutes elapsed in the communication session.

15. The method of claim 10, further comprising routing a caller voice from the first input and output communication device to the second input and output communication device via the relay device.

16. The method of claim 10, further comprising communicating voice signals of an interpreter at the relay device to the second input and output communication device and sign language from the interpreter to the first input and output communication device.

17. The method of claim 10, further comprising routing a called person's voice from the second input and output communication device to the first input and output communication device via the relay device.

18. A system for relaying communications between a first device and a second device utilizing a relay device as an intermediary where the second device is a telephone on a plain old telephone system network and the first device and the relay device utilize video in communication, the system comprising:
means for communicating with a first input and output communication device coupled to a network, the first input and output device being configured to send and receive video, audio, and text communication messages;
means for separating video, audio, and text communication messages from the first input and output communication device;
means for receiving the separated text, video, and audio communication messages at a relay communication device and means for establishing a communication session between the first input and output communication device and the relay device; and
means for communicating with a second input and output communication device over a plain old telephone system network communications based on the communications received from the first input and output communication device.

19. The system of claim 18, wherein the audio communication between the first input and output communication device and the relay communication device is communicated using internet protocol (IP).

20. The system of claim 18, wherein the video communication between the first input and output communication device and the relay input and output communication device comprises sign language.
